(19) United States
(12) Patent Application Publication
(10) Pub. No.: US 2018/0317175 A1
(43) Pub. Date: Nov. 1, 2018

(54) METHOD FOR SECURING AVAILABILITY OF MOBILE TERMINAL DEVICE AND INFORMATION PROCESSING DEVICE

(71) Applicant: LENOVO (SINGAPORE) PTE. LTD., Singapore (SG)

(72) Inventors: YUICHIRO SETO, YOKOHAMA (JP); YASUMICHI TSUKAMOTO, YOKOHAMA (JP)

(73) Assignee: LENOVO (SINGAPORE) PTE. LTD., SINGAPORE (SG)

(21) Appl. No.: 15/642,502

(22) Filed: Jul. 6, 2017

(30) Foreign Application Priority Data
Apr. 27, 2017 (JP) 2017087912

(51) Int. Cl. H04W 52/02; H04W 68/00

(52) U.S. Cl. CPC H04W 52/0251; H04W 68/005; H04W 52/0212

(57) ABSTRACT

To secure the availability of a battery operation of a grouped plurality of mobile terminal devices. Grouped devices can communicate with a management server through a network. The management server stores state data received from the devices in a management table. The state data contains proximity information for judging the length of time until a user checks a screen and availability information associated with the availability of the battery operation. The management server selects a target device requiring a predetermined action and a notification device notifying a message associated with the predetermined action based on the state data from the plurality of devices. The management server notifies the notification device of a message associated with the predetermined action. The message can be a charging prompt or an approval for shutdown.

### FIELD OF THE INVENTION

The present invention relates to a technique of securing the availability of a battery operation of a plurality of mobile terminal devices grouped on a network.

### BACKGROUND OF THE INVENTION

Some users possess a plurality of mobile terminal devices, such as a smart phone, a tablet terminal, and a laptop personal computer (laptop PC), which each are connectable to a network and operate with a battery. Patent Document 1 discloses a technique of preventing a reduction in service quality accompanying a reduction in the battery remaining amount of a plurality of user terminals possessed by the same user. Patent Document 1 describes that each user terminal transmits notification information according to the battery remaining amount to a management server, and then the management server stops the provision of the service to the user terminal with a small battery remaining amount, whereby the user terminal is prevented from early battery exhaustion due to continuous use of the service.

Patent Document 2 discloses watching system utilizing a smart phone. Patent Document 2 describes that data collected by a smart phone disposed in a dwelling unit of a watching target is sent to a server, and then a watching system operator inspects the data. Patent Document 3 discloses a cellular phone notifying a user of power supply shortage due to rechargeable battery exhaustion.

[Patent Document 1] Japanese Patent Application Laid-Open No. 2014-99757

[Patent Document 2] Japanese Patent Application Laid-Open No. 2016-146150

[Patent Document 3] Japanese Patent Application Laid-Open No. 2017-33414

### SUMMARY OF THE INVENTION

The plurality of mobile terminal devices possessed by a user generally includes one having a high use frequency and one having a low use frequency. In a mobile terminal device which has not been used over a long period of time, the charging management by a user is insufficient. For example, in a mobile terminal device which has been left in a sleep state over a long period of time, the battery remaining amount decreases, which results in the fact that, even when the mobile terminal device is actually used, the mobile terminal device cannot be used until charging is completed.

When attending a meeting where a laptop PC is used over a long period of time, the laptop PC needs to be fully charged in advance. However, a user sometimes forgets to charge the laptop PC due to careless overlooking of the schedule of the meeting. Or, a situation can also be assumed in which, in a mobile terminal device which is present at a distant place, an unexpected program suddenly runs, so that the battery is consumed in a short period of time. Thus, when a user possesses a plurality of mobile terminal devices, the availability has been required which sets each mobile terminal device into a state of being operatable with a battery when the user uses the same. It is an object of the present invention to secure the availability of a battery operation of a grouped plurality of mobile terminal devices.

One aspect of the present invention provides an information processing device capable of communicating with a plurality of mobile terminal devices grouped on a network. The information processing device has a state data recording portion recording state data received from a plurality of mobile terminal devices, a device selection portion selecting a target device which requires a predetermined action for securing the availability of a battery operation out of the plurality of mobile terminal devices and a notification device which is notified of a message associated with the predetermined action referring to the state data, and an action execution portion notifying the notification device of the message.

The information processing device may be a management server not belonging to the group or may be one of the mobile terminal devices belonging to the group. The state data can contain availability data which the device selection portion utilizes in order to judge the availability of the battery operation and proximity data which the device selection portion utilizes in order to judge the length of the time until a user checks a screen. Usable as the message is a request for obtaining a charging prompt and approval for shutdown.

Another aspect of the present invention provides a mobile terminal device capable of being grouped with another mobile terminal device on a network to which an information processing device is connected. The mobile terminal device has a state data generating portion generating state data for judging the availability of a battery operation, a state data transmitting portion transferring the state data to the information processing device, and a message receiving portion receiving a message associated with an action to another mobile terminal device selected out of a plurality of mobile terminal devices based on the state data by the information processing device. The information processing device may be another grouped mobile terminal device.

The present invention has enabled securing of the availability of a battery operation of a grouped plurality of mobile terminal devices.

### BRIEF DESCRIPTION OF THE DRAWINGS

FIG. 1 is a view for explaining grouped devices 100 according to an embodiment of the present invention.

FIG. 2 is a functional block diagram for explaining the configuration of a management server 200.

FIG. 3 is a view for explaining one example of the data structure of a management table 209.

FIG. 4 is a functional block diagram for explaining the configuration of the device 100.

FIG. 5 is a flow chart for explaining one example of a procedure in which the management server 200 secures the availability of the device 100.

FIG. 6 is a flow chart showing one example of a procedure for selecting a target device.

FIG. 7 is a flow chart showing one example of a procedure for selecting a notification device.

### DETAILED DESCRIPTION OF THE INVENTION

[Operation Environment of Device Group 100]

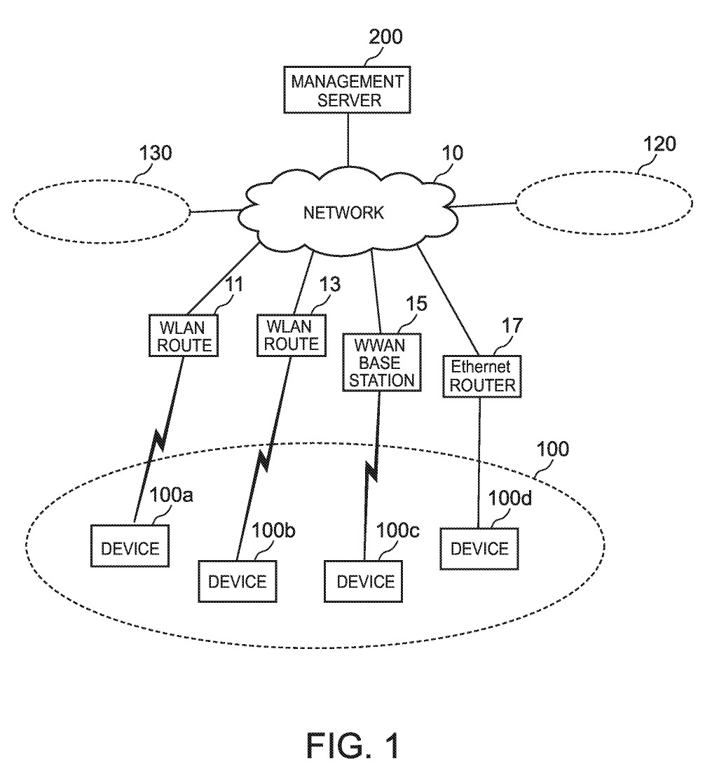

FIG. 1 is a view for explaining grouped devices 100 according to an embodiment of the present invention. A network 10 includes one or two or more of networks, such as a PAN (Personal Area Network), a LAN (Local Area Network), a MAN (Metropolitan Area Network), a WAN (Wide Area Network), the Internet, and the Intranet. To the network 10, a management server 200 and connection devices to the network 10, such as wireless LAN routers 11 and 13, a wireless WAN base station 15 of mobile body communication standard, such as 3G, LTE, or WiMAX, and an Ethernet (Registered Trademark) router 17 are connected.

In one example, it is supposed that the wireless LAN router 11 is disposed in an office and the wireless LAN router 13 and the Ethernet router 17 are disposed in the home. FIG. 1 illustrates grouped device groups 100, 120, and 130. The device groups 100, 120, and 130 configure different groups but each group similarly operates in the present invention, and therefore hereinafter the grouped devices 100 are representatively described.

Devices 100a to 100d grouped herein have identifiers on the network which the management server 200 can identify according to the range of possession, management, or control by a user. FIG. 1 illustrates, as the grouped devices 100, the device 100a connected to the wireless LAN router 11, the device 100b connected to the wireless LAN router 13, the device 100c connected to the wireless WAN base station 15, and the device 100d connected to the Ethernet router 17 with a cable. Hereinafter, arbitrary devices 100a to 100d which do not need to be specified are also indicated as the devices 100.

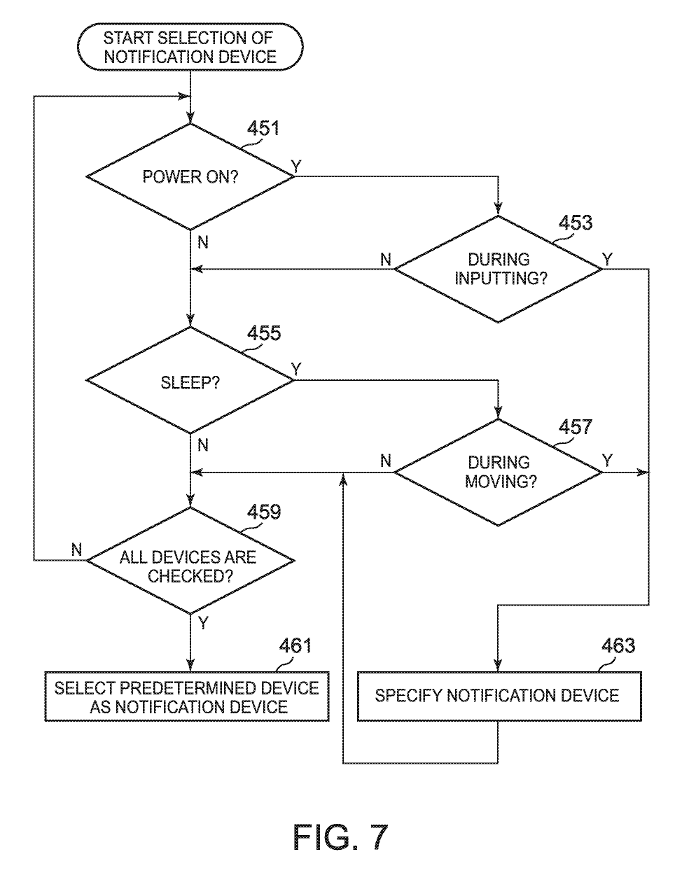

Usable as the device 100 are information terminal devices, such as a smart phone, a cellular phone, a tablet terminal, and a laptop PC, household electric appliances, such as a game machine and a digital camera, and industrial devices, such as a measuring instrument and a wireless unit, as one example. The devices 100a to 100c each are equivalent to a mobile terminal device which can operate with a battery. Usable as the device 100d is a desktop PC which operates only with a commercial power source. The device 100d is sometimes selected as a notification device described with reference to FIG. 7.

The devices 100a to 100c are movable to be connected to the network 10 from other different connection devices. The devices 100 each transmit state data utilized for securing of the availability of the battery operation to the management server 200. The management server 200 carries out an operation for securing the availability of the battery operation of the devices 100a to 100c based on the state data received from the devices 100.

[Management Server]

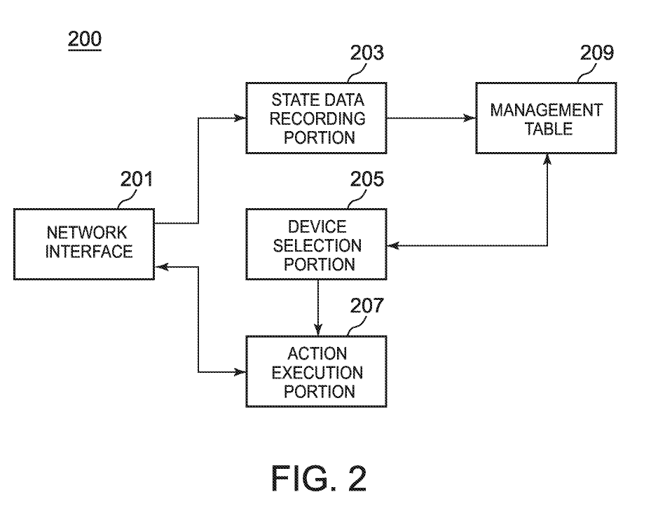

FIG. 2 is a functional block diagram for explaining the configuration of the management server 200. The management server 200 can provide service according to the present invention to the grouped plurality of devices 100, 120, and 130. The management server 200 may be one managed for the public by a business operator providing a cloud service or may be one managed only for employees by ordinary enterprises.

The management server 200 contains a network interface 201, a state data recording portion 203, a device selection portion 205, an action execution portion 207, and a management table 209. As the constituent components of the management server 200, the management server 200 is configured by cooperation of hardware, such as a processor, a system memory, a controller, and an I/O chip set, and software, such as a device driver, an OS, and an application.

The network interface 201 controls data transfer between the management server 200 and the network 10. The state data recording portion 203 records the state data received from the devices 100 in the management table 209. The state data recording portion 203 can process the received state data into state data which the device selection portion 205 easily utilizes when selecting a notification device and a target device, and then record the processed state data.

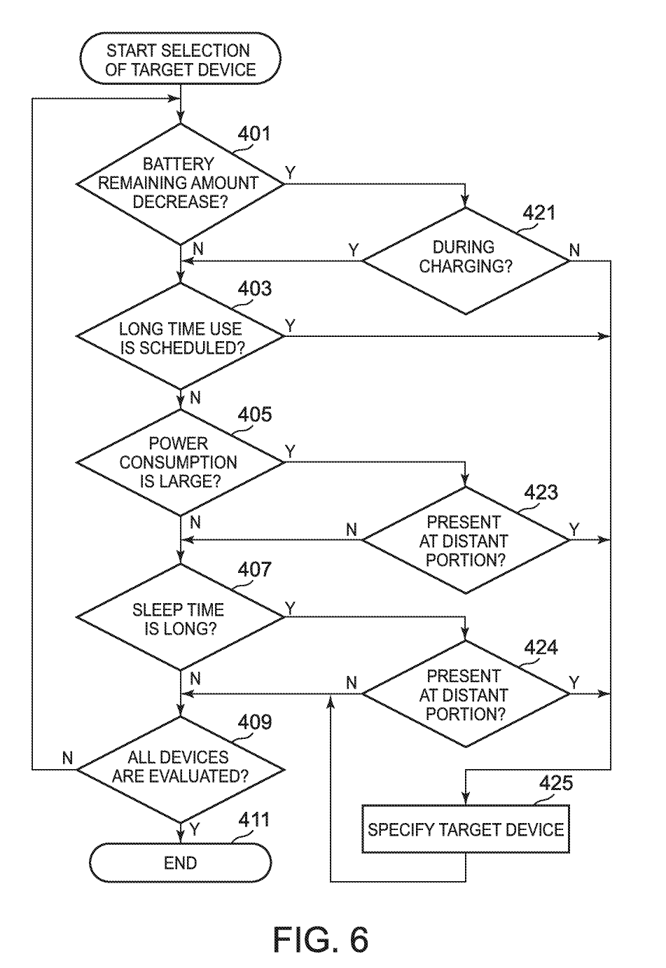

The notification device and the target device are described with reference to FIG. 6 and FIG. 7. The device selection portion 205 selects a notification device and a target device referring to the management table 209. The action execution portion 207 transmits a request for obtaining a prompt for a predetermined action or approval for shutdown by a user to a notification device. When the approval for shutting down the target device is obtained from the notification device, the action execution portion 207 sends a control command for performing shutdown to the target device.

[Management Table]

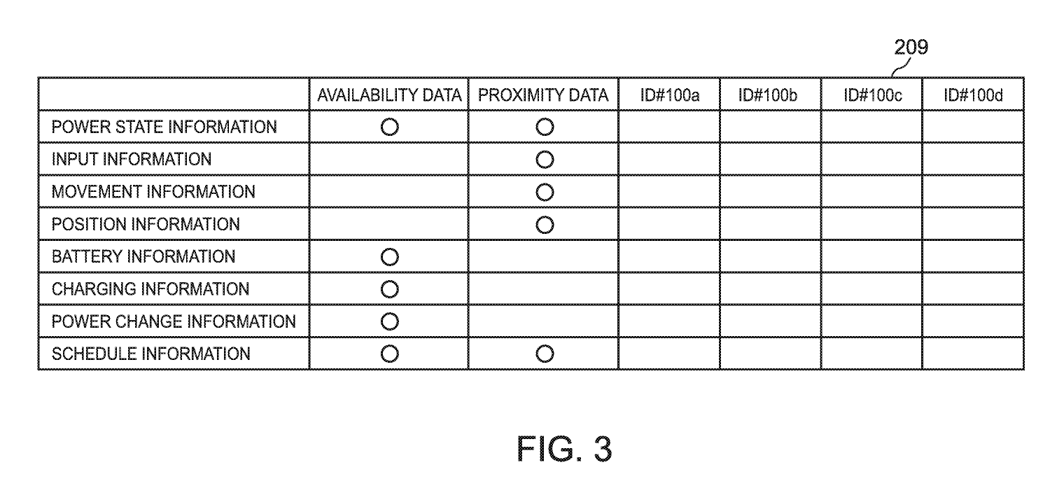

FIG. 3 is a view for explaining one example of the data structure of the management table 209. Herein, the state data is equivalent to data which the management server 200 utilizes in order to secure the availability of the battery operation of the devices 100. The state data contains information (proximity data) required for judgment of the relative length of the time until a user checks a screen and information (availability data) required for judgment of the availability about the battery operation. The management server 200 selects a notification device which serves as a partner which the management server 200 notifies of an action based on the proximity data and selects a target device serving as an action execution target based on the availability data. Both the notification device and the target device are equivalent to a part or all of the grouped devices 100.

The management table 209 contains a record containing device identifiers ID#100a to ID#100d of the devices 100a to 100d and the classification of the availability data and the proximity data and a field containing power state information, input information, movement information, and the like. The power state information is equivalent to availability data and proximity data which show the power state, such as a power-on state, a sleep state, or a power-off state, to which the device 100 currently causes the transition.

The devices 100 transmit the time when the power state changes to the management server 200. In one example, immediately after the power supply is started, the devices 100 transmit the power-on time to the management server 200 and, immediately before a transition operation to the sleep state or the power-off state, the devices 100 transmit the time thereof. When automatic power-off in which the state is automatically changed to the power-off state from the sleep state is set, the devices 100 transmit the time when the devices 100 automatically cause the transition to power-off to the management server 200.

The state data recording portion 203 can recognize a current power state from the time when these power states change to generate the power state information. The power state information may be generated, and then sent to the management server 200 by the devices 100. The devices 100 can periodically wake up to transmit the state data also in the sleep state.

The input information is equivalent to the proximity data which gives rise to an estimate that a user may immediately see the screen of the device 100 among the devices 100a to 100d. In one example, usable as the input information is information that a user operates input devices provided in the device 100, such as a touch panel, a keyboard, and a mouse. In another example, usable as the input information is information showing performing streaming reproduction of music or moving images.

In one example, the devices 100 can send the input information when the input device is operated and send information showing the cancellation of the input information when a fixed period of time has passed after the final input device operation stops to the management server 200. The movement information is equivalent to the proximity data showing the devices 100a to 100c are held by a user during movement to be swaying.

In one example, usable as the movement information is information output by an acceleration sensor mounted on the devices 100a to 100c. The position information is equivalent to proximity data showing the geographical location of the devices 100. In one example, usable as the position information is GPS information and identification information of the connected wireless LAN routers 11 and 13 or wireless WAN base station 15. The position information of a smart phone which is expected to be carried by a user can also be simultaneously utilized for the estimate of the current position of the user. The management server 200 can also estimate the current position of a user from the position information and the movement information.

The battery information is equivalent to availability data showing the amount of the electricity remaining in batteries mounted on the devices 100a to 100c. Usable as the battery information is the ratio (remaining amount ratio) of the remaining electricity amount to the rated capacity or full charge capacity of the battery. The devices 100 can periodically notify the management server 200 of the remaining amount ratio or send the battery information when the remaining amount ratio decreases to a predetermined value to the management server 200 and, when recovered due to charging, send information showing that the devices 100 is recovered.

Charging information is equivalent to availability data showing that the devices 100a to 100c currently charge the batteries. The devices 100 can send the charging information when charging has been started and send information showing that the charging has stopped when the charging has been completed to the management server 200. Power change information is equivalent to the availability data showing that an unexpected program, such as a virus program, has started the operation, so that the power consumption of the devices 100a to 100c has rapidly increased. In one example, the devices 100 calculate the movement average for each predetermined period of time of the power consumption.

The devices 100 send the power change information to the management server 200 in the occurrence of a change equal to or larger than a predetermined value as compared with the power profile showing the usual power consumption. The power profile is equivalent to the tendency of the power consumption of the devices 100 corresponding to a time zone or a day of the week. The devices 100 can statistically process the periodically acquired power consumption size to create the power profile.

Schedule information is equivalent to the availability data and the proximity data showing the action schedule of a user associated with the use of the devices 100. In one example, usable as the schedule information is data registered in a schedule table showing a schedule of using the devices 100a to 100c over a long period of time, such as a time zone of a meeting, a time zone of a business trip, and a time zone of movement by train. The schedule table recording the schedule information may be held by either the management server 200 or the device 100. The management server 200 can estimate, from the schedule information, the current position of a user and the device 100 having a high use frequency by a user at that time.

[Device 100]

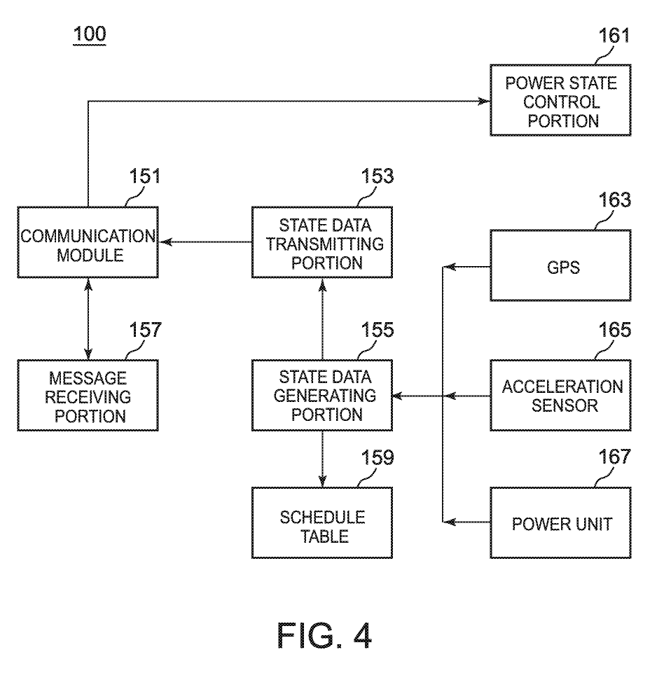

FIG. 4 is a functional block diagram for explaining the configuration of the device 100. The device 100 contains a state data transmitting portion 153, a state data generating portion 155, a schedule table 159, a power state control portion 161, and a message receiving portion 157. These elements can be configured by cooperation of hardware, such as a CPU, a system memory, and a display, and software, such as an OS and an application.

The device 100 further contains a communication module 151, a GPS 163, an acceleration sensor 165, and a power unit 167. The communication module 151 is configured from a controller for connection with the wireless LAN routers 11 and 13, the wireless WAN base station 15, and the Ethernet router 17. The state data generating portion 155 generates the state data illustrated in FIG. 3 based on data acquired from the communication module 151, the GPS 163, the acceleration sensor 165, and the power unit 167.

The state data transmitting portion 153 sends the state data to the management server 200 periodically or as necessary. The schedule table 159 records the action schedule of a user. The action schedule of a user may be registered in the management server 200. In one example, the message receiving portion 157 contains a touch screen and displays a message associated with the action to the target device received from the management server 200. The message receiving portion 157 sends a direction to a user request to the management server 200 when the message is a request for approval for shutdown.

The power state control portion 161 causes the transition of the device 100 to the power-off state from the power-on state or the sleep state in response to a control command received from the management server 200. The power unit 167 contains a battery, a charger, a DC/DC converter, and the like and outputs the battery remaining amount, information during charging, the power consumption, and the like to the state data generating portion 155. The management server 200 selects the device 100 as both or either the notification device and/or the target device.

[Procedure of Securing Availability]

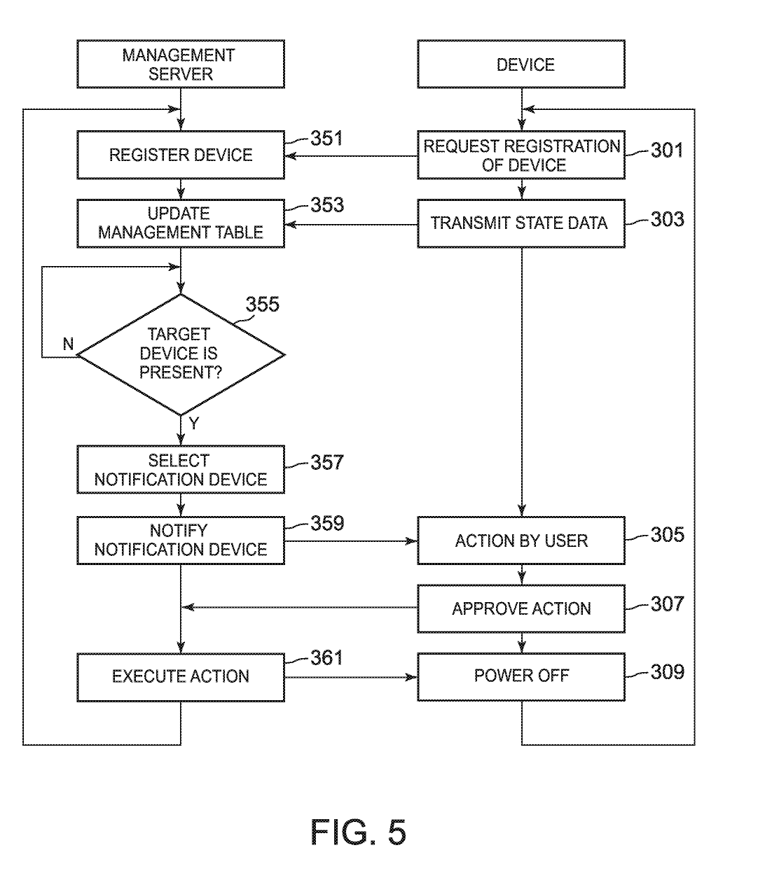

FIG. 5 is a flow chart for explaining one example of a procedure in which the management server 200 secures the availability of the devices 100. The devices 100 operate as the device transmitting the state data and both or either the notification device and/or the target device selected by the management server 200. In Block 301, a user attaches group identifiers to the devices 100 to be added to a group, and then registers the same in the management server 200. In Block 351, the management server 200 attaches the device identifier ID#100a to 100d to the corresponding devices 100a to 100d, and then registers the same in the management table 209 created for each group.

In Block 303, the devices 100 each send the state data described with reference to FIG. 3 to the management server 200 at predetermined timing or as necessary. In Block 353, the state data recording portion 203 processes the received state data as necessary, and then registers the same in the management table 209 or updates the management table 209. In Block 355, the device selection portion 205 periodically judges whether the target device serving as the target of the action is present referring to the management table 209. A method for selecting the target device is described with reference to FIG. 6.

When the target device is present, the device selection portion 205 selects the notification device equivalent to the device 100 in which a user easily notices a message in a short time at that time referring to the management table 209 in Block 357. A method for selecting the notification device is described with reference to FIG. 7. In Block 359, the action execution portion 207 sends a message associated with the action to the target device by push delivery to the selected notification device.

In one example, usable as the message associated with the action is a charging prompt, a checking prompt when power higher than usual is consumed, or a request for approval for forcibly shutting down the power supply of the target device by a user of the target device. When the action is only the transmission of a message to a user, the processing of the management server 200 ends at this time, and then a user seeing the message takes action of charging or checking the target device in Block 305.

When the message is a request for approval for shutdown, a user operates the notification device to send a response of approval or disapproval to the management server 200 in Block 307. When the action execution portion 207 sends a control command to the target device when the action is approved in Block 309, the power state control portion 161 of the target device causes the transition of a system to the power-off state in Block 361. According to Block 305, a user can charge a battery in advance and, according to Block 309, the continuation of the sleep state in a state where the use thereof is not scheduled can be prevented or unusual battery consumption can be prevented, and therefore the availability of the battery operation can be secured.

[Selection of Target Device]

FIG. 6 is a flow chart showing an example of a procedure for selecting a target device. The target device is equivalent to the devices 100a to 100c in the grouped devices 100 to which the management server 200 or a user needs to take a certain action in order to secure the availability of the battery operation, such as charging of a battery or control of the power state. The device selection portion 205 periodically evaluates the plurality of devices 100a to 100c registered in the management table 209 in order to judge the suitability as the target device.

In Block 401, the device selection portion 205 judges whether the remaining amount ratio of the device 100 to be evaluated has decreased to be smaller than the predetermined value referring to the battery information. The device selection portion 205 judging that the remaining amount ratio has decreased judges whether the device 100 is under charging or under discharging in Block 421. When the device 100 is under charging, the device selection portion 205 shifts to Block 403. When the device 100 is under discharging, the device selection portion 205 shifts to Block 425.

In Block 425, the device selection portion 205 specifies the device 100 which is under discharging and in which the remaining amount ratio has decreased to be smaller than a predetermined value as the target device in order that the device 100 can be immediately used without charging. In Block 403, the device selection portion 205 judges whether the device 100 is scheduled to be used over a long period of time in the near future from the schedule information and the time at this point.

In Block 425, the device selection portion 205 judging that the device 100 is scheduled to be used over a long period of time in the near future specifies the device 100 as the target device 100 that the target device 100 is fully charged in advance. In Block 405, the device selection portion 205 judging that the device 100 is not scheduled to be used over a long period of time judges whether the power consumption of the device 100 has rapidly increased referring to the power change information. When it is judged the power consumption of the device 100 has rapidly increased, the device selection portion 205 shifts to Block 423.

In Block 423, the device selection portion 205 judges whether the device 100 is present at a place distant from a user or present near a user. The device selection portion 205 can judge the position of a user and the position of the device 100 from the proximity data of the management table 209. The device 100 in which the power consumption has rapidly increased has a high possibility that a virus program starts the operation or abnormalities occur.

On the other hand, during the actual use of the device 100, even when the power consumption rapidly increases, a user can immediately respond to the increase. The device selection portion 205 judging that the device 100 is present at a distant place in Block 423 specifies the device 100 as a target device in order to shut down the same in Block 425. The device selection portion 205 judging that the device 100 is not present at a distant place or the power consumption does not rapidly increase shifts to Block 407.

In Block 407, the device selection portion 205 judges whether the device continues the sleep state for a predetermined time or longer referring to the power state information. In Block 424, the device selection portion 205 judging that the device 100 continues the sleep state for a predetermined time or longer judges whether the device 100 is present at a place distant from a user or near user. In Block 425, the device selection portion 205 judging that the device 100 is present at a distant place specifies the device 100 as the target device in order to shut down the same.

The device selection portion 205 judging that the device 100 is not present at a distant place or the sleep time is not long shifts to Block 409. The device selection portion 205 shifts to Block 409 after specifying the target device in Block 425. In Block 409, the device selection portion 205 returns to Block 401 to evaluate all the devices 100 registered in the management table 209, and then ends the selection processing of the target device in Block 411. In the procedure of FIG. 6, a plurality of target devices are selected in some cases and, in this procedure, no target devices are selected.

[Selection of Notification Device]

FIG. 7 is a flow chart illustrating an example of a procedure for selecting a notification device. The notification device is equivalent to the device 100 having a high possibility that a user can check messages received from the management server 200 in a short time at the time among the devices 100a to 100d. A plurality of notification devices may be selected but, in order to avoid the inconvenience of receiving unnecessary messages by a large number of devices 100, it is desirable to select a device having the highest possibility that a user checks a message in a short time.

The device selection portion 205 evaluates the plurality of devices 100 registered in the management table 209 in order to judge the suitability as the notification device. In Block 451, the device selection portion 205 judges whether the device 100 to be evaluated is currently in the power-on state referring to the power state information of the management table 209. The device 100 in the power-on state gives rise to an estimate that a user is present in the neighborhood. When the device selection portion 205 judges that the device 100 is in the power-on state, the device selection portion 205 shifts to Block 453. When the device selection portion 205 judges that the device 100 is in the sleep state or the power-off state, the device selection portion 205 shifts to Block 455. In Block 453, the device selection portion 205 judges whether a user is performing an input to the device 100 from the input information.

A message which is push-delivered to the device 100 during inputting has a high possibility that a user can immediately check the message. The device selection portion 205 judging that a user is performing an input specifies the device 100 as the notification device in Block 463. The notification device is sometimes different from the target device or sometimes the same as the target device. For example, the device 100 is selected as the notification device when a user is using his/her laptop PC and is selected as the target device based on the schedule information showing a tomorrow morning meeting, so that the device sometimes receives a charging prompt.

The device selection portion 205 can also immediately select the device 100 in the power-on state as the notification device while omitting the procedure of Block 453. In this case, two or more of the devices 100 may be selected as the notification device. The device selection portion 205 judges whether the device 100 is in either the sleep state or the power-off state from the power state information in Block 455. When the device 100 is judged to be in the sleep state, the device selection portion 205 shifts to Block 457. When the device 100 is judged to be in the power-off state, the device selection portion 205 shifts to Block 459.

In Block 457, the device selection portion 205 judges whether the device 100 is moving from the movement information. When the device 100 in the sleep state is moving, a possibility that a user holds the device 100 is high. Therefore, it can be estimated that a user checks push delivery in a short time, and thus the device selection portion 205 selects the device 100 as the notification device in Block 463. In Block 459, the device selection portion 205 returns to Block 451 to repeat the same procedure until the device selection portion 205 judges whether all the devices 100 are appropriate as the notification device.

In Block 461, when the device selection portion 205 cannot select any device 100 as the notification device in the procedure of Blocks 451 to 459, the device selection portion 205 selects a predetermined device 100 as the notification device. Usable as the predetermined device is a smart phone which is set in advance as a device having a high possibility that a user is present in the neighborhood, for example. Or, the device selection portion 205 can select a device around which a user can be estimated to be present from the movement information, the position information, and the schedule information as the notification device.

For example, when a user is present in an office, the device selection portion 205 can select a desktop PC or a laptop PC which is usually used in the office as the notification device. Or, when it is currently the schedule time of a meeting, the device selection portion 205 can select a laptop PC or a tablet terminal which is usually used in the meeting as the notification device. Or, when the device 100 is present at a place different from a place where the device 100 is usually used, a possibility that the user carries the device 100 to the movement destination to use the same is high. Therefore, the device selection portion 205 can select the device 100 as the notification device.

As described above, the procedure is described in which the management server 200 secures the availability of the battery operation of the grouped devices 100 but any one of the devices 100 belonging to the group can also perform the procedure of the management server 200. The data structure of the management table 209 of FIG. 3 and the procedure illustrated in FIG. 5 to FIG. 7 describe one embodiment of the present invention. The scope of the present invention is as described in Claims which can be imagined by a person skilled in the art from the description of this specification.

The present invention is described with reference to a specific embodiment illustrated in the drawings but it is a matter of course that the present invention is not limited to the embodiment illustrated in the drawings and any configuration known so far can be adopted insofar as the effects of the present invention are demonstrated.

We claim:

1. An information processing device capable of communicating with a plurality of mobile terminal devices grouped on a network, the information processing device comprising:
a state data recording portion that records state data received from the plurality of mobile terminal devices;
a device selection portion that selects, from the plurality of the mobile terminal devices and with reference to the state data, a target device that requires a predetermined action for securing the availability of a battery operation, and a notification device which is notified of a message associated with the predetermined action; and
an action execution portion that notifies the notification device of the message.

2. The information processing device according to claim 1, wherein:
the state data contains availability information which the device selection portion utilizes in order to judge the availability of the battery operation and proximity information which the device selection portion utilizes in order to judge a length of time until a user checks a screen.

3. The information processing device according to claim 1, wherein:
the device selection portion selects, as the notification device, a mobile terminal device that is transmitting the state data which allows judgement that the mobile terminal device is in an input state by a user.

4. The information processing device according to claim 1, wherein:
the device selection portion selects, as the notification device, a mobile terminal device that is transmitting the state data which allows judgement that the mobile terminal device is moving while being held by a user.

5. The information processing device according to claim 1, wherein:
the device selection portion selects, as the notification device, a mobile terminal device that is transmitting the state data which allows judgement that the mobile terminal device is in a power-on state.

6. The information processing device according to claim 1, wherein:
the device selection portion selects, as the target device, a mobile terminal device that is transmitting the state data which allows judgement that a battery remaining amount is decreasing.

7. The information processing device according to claim 1, wherein:
the device selection portion selects, as the target device a mobile terminal device that is transmitting the state data which allows judgement that the mobile terminal device has started an operation with a power higher than a predetermined power consumption, and that the mobile terminal device is present at a position distant from a user.

8. The information processing device according to claim 1, wherein:
the device selection portion selects, as the target device, a mobile terminal device that is transmitting the state data which allows judgement that a predetermined time has passed after a transition to a sleep state and that the mobile terminal device is present at a position distant from a user.

9. The information processing device according to claim 1, wherein:
the device selection portion selects, as the target device a mobile terminal device that is transmitting the state data which allows judgement that a schedule of using the mobile terminal device over a long period of time is present or absent.

10. The information processing device according to claim 1, wherein:
the message is a charging prompt to a user.

11. The information processing device according to claim 1, wherein:
the message is a request for approval to shut down the target device.

12. The information processing device according to claim 1, wherein:
the predetermined action is a transmission of a command to shut down the target device.

13. A mobile terminal device capable of being grouped with another mobile terminal device on a network to which an information processing device is connected, the mobile terminal device comprising:
a state data generating portion that generates state data for judging availability of a battery operation;
a state data transmitting portion that transfers the state data to the information processing device; and
a message receiving portion that receives a message associated with an action to the another mobile terminal device, wherein the another mobile terminal device is selected out of the plurality of mobile terminal devices based on the state data processed by the information processing device.

14. The mobile terminal device according to claim 13, comprising:
a power state control portion that receives a command for executing the action to perform a shutdown process.

15. A method for securing availability of a battery operation of a plurality of mobile terminal devices grouped on a network by an information processing device, the method comprising:
receiving from the plurality of mobile terminal devices, state data of each of the plurality of mobile terminal devices,
selecting a target device that requires a predetermined action for securing the availability of the battery operation based on the state data from the plurality of mobile terminal devices,
selecting a notification device based on the state data from the plurality of mobile terminal devices; and
sending a message, associated with a predetermined action to the target device, to the notification device.
